(19) United States
(12) Patent Application Publication
(10) Pub. No.: US 2021/0011685 A1
(43) Pub. Date: Jan. 14, 2021

(54) System and Method for Storing Data Records

(71) Applicant: DataJaguar, Inc, Danville, CA (US)

(72) Inventor: Jonathan Zhanjun Yue, Danville, CA (US)

(21) Appl. No.: 16/569,653

(22) Filed: Sep. 12, 2019

Related U.S. Application Data
(60) Provisional application No. 62/921,759, filed on Jul. 8, 2019.

(51) Int. Cl. G06F 7/16; G06F 16/22

(52) U.S. Cl. CPC G06F 7/16; G06F 16/2246

(57) ABSTRACT

The present disclosure discloses systems and methods for storing data records of a table or any data collection in a database system. The records are stored in a plurality of data files on a computer server. The system considers both the sequential I/O and random I/O options in the processing writing data records to a disk, and finds the best approach to writing data to the disk. Under certain conditions, the method analyzes and recognizes that sequential I/O may perform better. Under another condition, the method analyzes and recognize random I/O may perform better. Under other conditions, the method analyzes and recognizes a combination of sequential I/O and random I/O may perform better. The method chooses the option that has the minimum-cost for storing data records in a disk file. In doing so, the method considers and applies system constraints, such as memory resource and I/O latency.

### CROSS REFERENCE TO RELATED APPLICATIONS

This application claims the benefit of U.S. Provisional Patent 62/921,759, filed Jul. 8, 2019, the entirety of which is incorporated by reference.

### TECHNICAL FIELD

Embodiments of the present disclosure relate to storing data records, and more specifically to merging an input buffer into a simple file or a complex file.

### BACKGROUND OF THE DISCLOSURE

Mobile devices and electronic sensors are generating and transmitting data records at an all-time high rate. Database systems are often required to keep the enormous records sorted for fast indexing. The sorted data records may be stored in one file or a plurality of files on disk. In modern computer systems or data centers, hard disk drives (HDD) and Solid State Disks (SSD) are often used for data storage. SSDs are significantly faster than HDDs. Both HHDs and SSDs have faster sequential I/O than random I/O. In other database systems, sequential I/O is preferred to random I/O.

There exists a need in the art to address the issues described above.

### SUMMARY OF THE DISCLOSURE

In our disclosure, we also attempt to use sequential I/O as much as possible but in certain conditions, we prefer random I/O to sequential I/O. For example, when a small number of data records are written to disk, random writes may have better performance than sequential write. We evaluate various options and choose the best one in storing data records in a database system.

The present disclosure discloses systems and methods for storing data records of a table or any data collection in a database system. The records are stored in a plurality of data files on a computer server. The system considers both the sequential I/O and random I/O options in the processing writing data records to a disk, and finds the best approach to writing data to the disk. Under certain conditions, the method analyzes and recognizes that sequential I/O may perform better. Under another condition, the method analyzes and recognize random I/O may perform better. Under other conditions, the method analyzes and recognizes a combination of sequential I/O and random I/O may perform better. The method chooses the option that has the minimum-cost for storing data records in a disk file. In doing so, the method considers and applies system constraints, such as memory resource and I/O latency.

In this application, data records consisting of a key and a value are distributed in a plurality of data files in a database system. The terms “buffer”, and “memory buffer” both mean a chunk of memory in a computer system's main memory that has much higher I/O performance than HDD or SSD. The term “input buffer” means a buffer in memory for receiving and temporality storing data records that enter the system. An input buffer will eventually be written onto the disk for permanent storage. The terms “data file”, “disk file”, “simple file”, and “file” are used interchangeably without any important difference, meaning regular files stored on a disk. The term “complex file” refers to a sequence of simple files on disk to represent one logical file in whole. The files inside a complex file are simple files. A complex file is viewed as a container for simple files. The term “generic file” means either a simple file or a complex file. The term “user” refers to a person or a client program that may insert, read, update, or delete data in a database system. The term “server” or “node” can represent a physical computer with CPU, memory, permanent storage medium, or a virtual server instance in a cloud environment. The term “disk” means HDD, SSD, or any type of permanent storage medium. In a database system, one or more servers may be deployed to receive data from a user or provide data to the user. In each server, one or more data files can be used to store key-value data records. The key, or record key, in a data record uniquely identifies the record in the whole database system. The value in the data record contains all data in the record except the key. The key may consist of a plurality of data items, i.e., the key may be a composite key.

Embodiments of the present disclosure disclose systems and methods to store new incoming data records in an input buffer. Depending on the state of the input buffer and the generic files, the method then flushes the data records from the buffer to disk. The input buffer may also be merged with a generic file on disk. Data writes are conducted to satisfy system constraints and to maximize write efficiency. Adjustments may be made for the system to be more read-efficient or more write-efficient by applying a preference factor. A write-efficient database emphasizes on increasing write performance at the cost of data reads, while a read-efficient system emphasizes on read performance at the cost of data writes. The method organizes simple files into complex files in order to speed up the process of merging an input buffer with files on a disk.

Although specific advantages have been enumerated above, various embodiments may include some, none, or all of the enumerated advantages. Additionally, other technical advantages may become readily apparent to one of ordinary skill in the art after review of the following figures and description.

### BRIEF DESCRIPTION OF THE DRAWINGS

For a more complete understanding of the present disclosure and its advantages, reference is now made to the following description taken in conjunction with the accompanying drawings, in which like reference numerals represent like parts.

FIG. 1 schematically depicts our storage model which consists of an input buffer B in main memory, and a plurality of simple files, F1 and F2, and a plurality of complex files, L1 and L2.

FIG. 2 illustrates that data records in an input buffer B, are merged with data records in a simple file F1, and all the records are stored in another simple file E1.

FIG. 3 depicts a control module that contains lookup tables in a complex file.

FIG. 4 is a schematic diagram showing that an input buffer B is merged with a complex file L1 and the result is another complex file L2.

FIG. 5 is a schematic diagram showing that partial-merge is done between input buffer B and a complex file L1, forming another complex file L2.

FIG. 6 depicts another embodiment of managing simple files in a complex file by ordering of file names.

### DETAILED DESCRIPTION OF THE DISCLOSURE

It should be understood at the outset that, although exemplary embodiments are illustrated in the figures and described below, the principles of the present disclosure may be implemented using other techniques. The present disclosure should in no way be explicitly limited to the exemplary implementations and techniques illustrated in the drawings and described below. Additionally, unless otherwise specifically noted, articles depicted in the drawings are not necessarily drawn to scale.

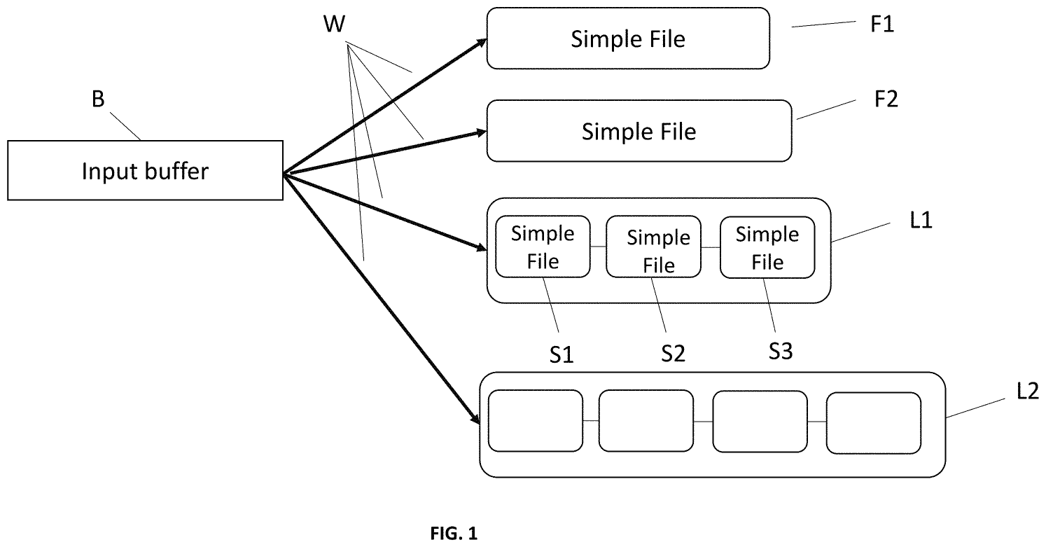

FIG. 1 is a schematic diagram that shows that at any time, there is an input buffer B receiving and holding data records from clients, and a plurality of simple files, illustrated by F1, F2, or more simple files, and a plurality of complex files, illustrated by L1 and L2, or more complex files. The system records and manages such a list of generic files. The input buffer is a block of main memory in the system. It acts as a queue to temporarily hold incoming data records to the system. After reaching a certain state (for example when the number of records in the input buffer exceeds a threshold or a timer has expired), the records in the buffer may be flushed and stored on the disk. The records from the input buffer may be written to a new simple file on disk. The new simple file may contain empty positions (holes) that allows for direct insertion of new records into the file without the need of a full merge. A hole is a blank record and contains no data. It is only a place holder. The records in the buffer may also be merged with an existing simple file or with a complex file. A complex file, logically functioning as one file, is physically composed of a sequence of simple files.

In a preferred embodiment, data records can be inserted anywhere in a complex file (such as at the head, tail, or any position in between). It can be appreciated that this is a major improvement over a conventional file system such as the ext4 or the XFS, where data records can be appended at the end of a file, or can be replaced in a region of the file, but cannot be inserted in the middle of a file. In this embodiment, the data records in an input buffer, and records in a generic file are all sorted by record keys in either ascending or descending order. In this embodiment, the ascending order is used. In another embodiment, the record keys are sorted in descending order.

Merging of an input buffer with a generic file is conducted by comparing keys in the buffer and keys in the generic file and producing new ordered records. After merging the input buffer and the generic file, the system stores the aggregated records in a new generic file or an updated generic file which may contain unchanged simple files. In a preferred embodiment, any simple file may contain a plurality of blank records (holes) which are able to absorb more data records without requiring a merge. The number of holes is obtained from a predefined percentage, h, relative to the total number of actual data records. The parameter h may be predefined to take any value that is greater than or equal to zero. The holes in a simple file may be distributed with a uniform pattern or any other pattern. Inserting records into the holes, and thus filling the holes, requires random writes which may be actually faster than merging of input buffer and a simple file if the number of records are small. That is, a small number of random writes may be faster than a merge process which could require reading and writing much more records.

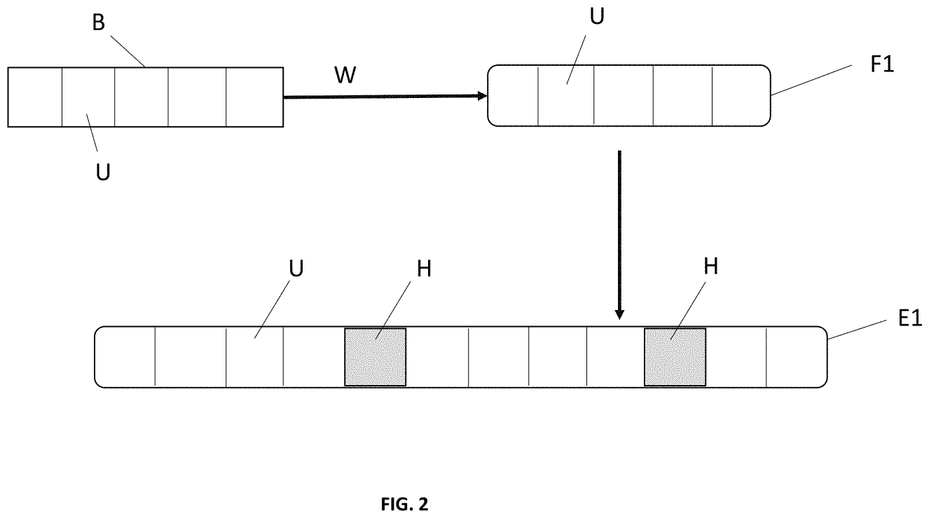

FIG. 2 illustrates records in an input buffer merging with a simple file F1 according to an embodiment of the present disclosure. In this embodiment, input buffer B holds a plurality of data records and U denotes one of such records in the buffer B. The records of buffer B may be structured as the well-known Binary Search Tree, or the B-Tree, or any other structure that keeps the records in sorted order. Simple file F1 contains independent sorted data records. File E1 denotes the final simple file as a result of the merge process W. Records from file F1 are read in chunks into a block of main memory and are compared to the records in the input buffer. The records of the least key and the next least keys are selected and written to an output buffer in memory. When the number of records in the output buffer reaches a predefined threshold, the output buffer is flushed to simple file E1 which may also contain holes sprinkled with a distribution pattern. All the records are kept sorted in the simple file E1, which may contain holes marked by symbol H.

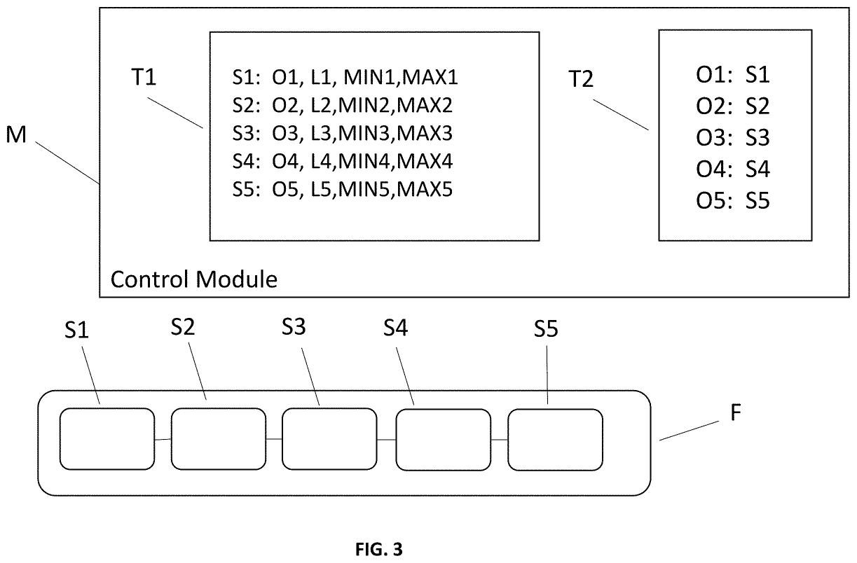

FIG. 3 depicts a complex file and a control module, M, that contains lookup tables, T1 and T2, for file names, offsets, file lengths, minimum key, maximum key, and any other metadata information, according to an embodiment of the present disclosure. It can be appreciated that the offset of an internal simple file within a complex file is the starting position of the simple file measured by the global scope of the complex file. The starting position indicates the position of its first record or byte in the simple file relative to the beginning of the complex file. In one embodiment, the offset of a simple file is the total data size of all the simple files preceding the simple file. In one embodiment, the data size is measured by the total number of records. In an alternative embodiment, the data size is measured by the total number of bytes. The embodiment in FIG. 3 uses the total number of records as the data size. The length of a simple file is the data size of the file. In table T1, S1 denotes a simple file, with O1 denoting the offset of the file, L1 denoting the length of the file, MIN1 and MAX1 denoting the minimum and maximum keys respectively in file S1. S2 denotes another simple file, with O2 denoting the offset of the file, L2 denoting the length of the file, MIN2 and MAX2 denoting the minimum and maximum keys respectively in file S2, and so on and so forth for other simple files (S3, S4, and S5). Tables T1 and T2 may contain information for any number of simple files. In table T2, the offsets are arranged in sorted order, that is, O1 is less than O2, which is less than O3, and so on and so forth. Other meta-data of a generic file may also be stored in the control module M.

Given a simple file name, the offset and length of the file can be quickly retrieved from table T1. Given an offset, the simple file that contains the offset is retrieved from table T2. The table T1 may be organized as the Binary Search Tree, B-Tree, hash table or any other structure for quickly finding strings. Table T2 may be organized as the Binary Search Tree or the B-Tree, or any other structure for managing ordered data records. If an offset is not found in table T2, then the predecessor of the offset is found and used. For example, if an offset O is between O3 and O4, then O3 is found and used by looking up the table T2. Offset O3 is the predecessor of O in table T2.

The offset is important because it helps to find a simple file to conduct data reads and data writes. If the system is to read or write data at any offset O, then the system first finds the offset or the predecessor of the offset from table T2. The simple file corresponding to the offset or its predecessor is then found and used. If we use P to denote the offset of the found simple file, denoted by G, then the read or write operation starts at location O−P (subtracting P from O) within the simple file G.

The simple files are S1, S2, S3, S4, and S5 in this particular embodiment. However, other embodiments comprise any number of simple files in a complex file. It should be appreciated that the data records are all in sorted order not only in each simple file, but also they are sorted in total order in the complex file. That is, the records in S1 are strictly less than or equal to the records in S2. The records in S2 are strictly less than or equal to the records in S3, and so on and so forth. By looking up table T2, the simple file that is responsible for an offset is found, and consequentially, file length, minimum and maximum keys are found in table T1.

The data entries in the control module may be maintained in both the main memory and on disk. If it is managed on disk, then changes in main memory are synchronized to the disk immediately or periodically. In case of power failure, system crash, or other scenarios where a system restart is needed, the system reads the control module from the disk and builds the control module in main memory.

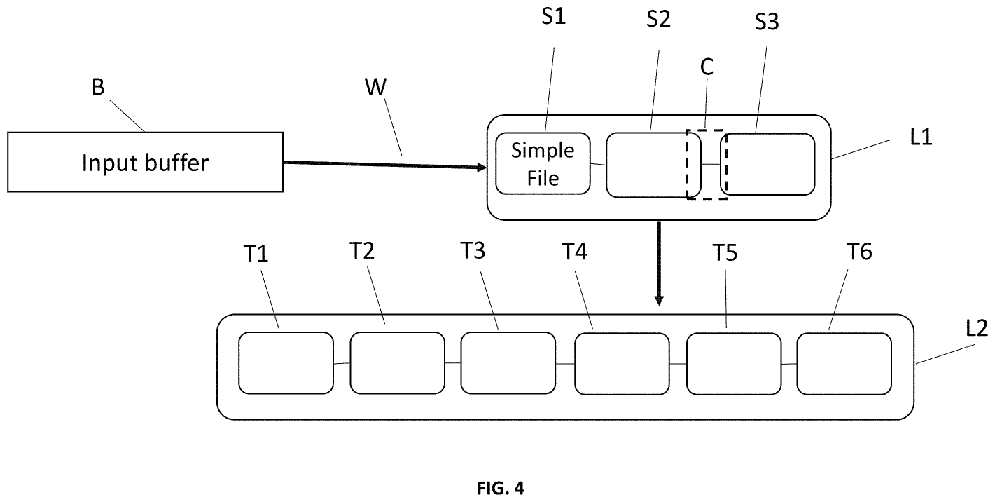

FIG. 4 illustrates data records in an input buffer merging with a complex file L1 according to an embodiment of the present disclosure. Input buffer B holds incoming data records and complex file L1 holds simple files S1, S2, and S3. In another embodiment, S1, S2, S3 may be individual chunks of disk space in a file system, where file names would be replaced by identification labels of the chunks without essential difference. The simple files are S1, S2, S3 in this illustrative embodiment. Other embodiments comprise any number of simple files in a complex file and each simple file may contain zero or a plurality of holes. According to an embodiment, a temporary block of data records, C, may be read into main memory each time from the simple files sequentially and are compared to the records in the input buffer. It can be appreciated that this technique leverages the high performance of sequential disk read. According to this embodiment, if the previous simple file has remaining size that is less than the size of the temporary block C, records in the next simple file are read to fill the temporary block.

A merge process is conducted by comparing records in B to the records in C. If the range of the keys in a simple file does not overlap with the range of the input buffer, then the records in the simple file are not merged with any records in the input buffer. Such simple files are called non-overlapping files, or clean files, which do not need any merge operations. Only the offset is updated for the non-overlapping simple files after the merge. The resulted complex file L2, may also consist of a plurality of internal simple files which may contain zero or a plurality of holes. According to an embodiment, the size of each file in L2 may be subject to a predefined limit. When the size of a simple file exceeds the limit, data is written to the next simple file, and so on and so forth. In this embodiment, data records in complex file L2 are also sorted. The simple files in a complex file may be managed by a linked-list structure, array structure, or efficient data structure for a sequence of data items. According to this embodiment, if a simple file has sufficient number of holes to absorb a portion of the records in the input buffer, then the merge process is not applied. Instead, the portion of the records in the input buffer are inserted directly into the simple file. Other records in the input buffer excluding this portion of the records may participate the merge process.

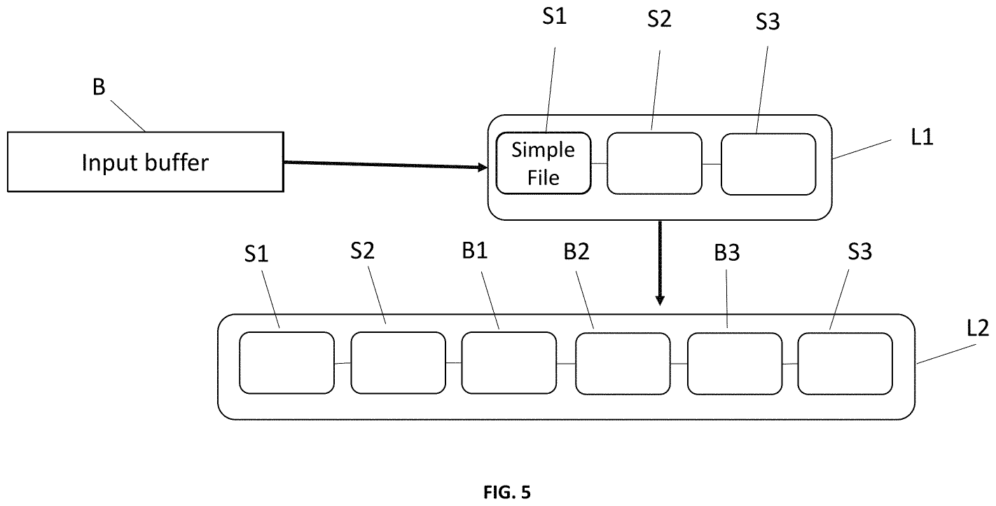

FIG. 5 illustrates non-overlapping simple files S1, S2, and S3 in a complex file L1, according to an embodiment of the present disclosure. The key in input buffer B is greater than the maximum key of file S2 and less than the minimum key in file S3. From table T1 in the control module M (see FIG. 3), it can be appreciated that the system can use the minimum and maximum keys of each simple file to check if buffer B overlaps with any simple file. For illustration purpose only, the records in buffer B are stored in three simple files B1, B2 and B3 which fall in between the records of simple files S2 and S3. By looking up the tables in the control module M, the non-overlapping simple files are recognized. This technique of structuring a complex file with a sequence of smaller simple files reduces the number of disk reads and writes in a merge process. Any non-overlapping files do not participate in the merge process. Only their offsets are updated in the lookup tables in the control module.

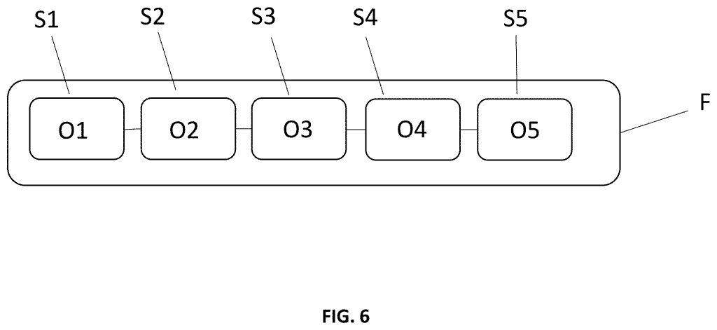

FIG. 6 illustrates another embodiment of initializing a control module during system restart. A restart is needed if the system suffers from power failure, device failure, or any other disasters. The initialization depends on the names of the simple files only instead of a separate disk file for the control module. This embodiment requires the system follow a naming convention when it creates a new simple file in a complex file.

In one particular embodiment, a simple file has the name in the format of “d1.d2.d3.d4 . . . ”, where d1, d2, d3, d4 are positive or negative numbers, and period “.” is level delimiter. Table N illustrates the name format of internal simple file names. The level delimiter can be replaced by any other character other than numbers. There can be any number of levels in the name of a simple file. The first level is characterized by d1, the second level by d2, the third level by d3, and so on and so forth. The file name is sorted by lexical order (dictionary order). It is similar to the ordering of chapters, sections, subsections in the Table Of Contents in a published book. For example, “1.1” is followed by “1.1.1”, which is followed by “1.1.2”, which may be followed by “1.2”. if a new simple file is to be inserted between file “2.3” and “2.4”, the name of the new file will be “2.3.1” which is interpreted to be greater than “2.3” but less than “2.4”. Since the simple files can be added in decreasing order in terms of record keys, negative numbers are used in a file name for the simple files. File names with negative numbers are also arranged with lexical order. For example, “−2” is preceded by “−2.−1”, which is preceded by “−2.−1.−1”. The data records in a simple file follows the same order as the file names themselves. For example, the record keys in file “1.1” are less than the record keys in file “1.1.1”. In another embodiment of present disclosure, letters are used in the file names instead of numbers. Table D illustrates the ordered list of simple files with names in our naming convention.

In another embodiment, in a complex file F, the name of a simple file (S1, S2, etc) contains the global offset of the file. In one embodiment, the global offset is the only component in the file name. In another embodiment, the offset is part of the file name. When comparing the order of file names, the system uses the numerical value of the offset in the file name for the numerical comparison. For example, in FIG. 2, file S1 has the name “O1”, the global offset of the file. File S2 has the name “O2”, the global offset of the file, and so on and so forth. When the offset of a simple file Sᵢ (i is the i-th simple file) is changed either because of inserting or removing block of records, then the name and offset of files Sⱼ (j>i) will also be updated to reflect the changes. The offset is decreased by the same amount of data that is removed. The offset is increased by the same amount of data that is inserted. The control module M in FIG. 3 may also need to be updated.

With this naming convention, it can be appreciated that no separate file storage for the control module is needed. During restart of the system, the simple file names belonging to a complex file are read and are sorted according to the order. The simple file names may be marked with different notations for different complex files. In modern file systems, file size can be retrieved from the file system for a given file. Since the records in a simple file is ordered, the system can obtain the minimum key and maximum key by inspecting the first record and the last record in the file using the file length. Therefore, the control module can be built by just scanning and ordering the simple files.

When an input buffer is written to disk or merged with generic files on disk, some constraints and metrics are used. One constraint is the limit of total number of records in the input buffer. If the total number of records in the input buffer goes over the limit, the input buffer may be directly flushed to a disk file without merging with any file on disk. The input buffer may also be merged with a generic file in another embodiment. Another constraint is the size of a complex file. When the size of a complex file exceeds a threshold, no more records can be written to the complex file. One metric is the cost of merging all the records to existing generic files. We measure the cost by the time required to finish a merge or a hole-filling process. The cost is computed by analyzing the time to be spent on sequential reads, sequential writes, or random writes in case of filling holes. For a complex file, key ranges of the simple files are used to select the corresponding records in the input buffer. If there are records in the buffer whose keys fall outside the key ranges of the simple files (the outlier records), then the outlier records are split and assigned to neighboring simple files. Each of the simple files are evaluated for the cost of data read and date write, by examining the number of sequential reads or writes and random writes. The cost for the complex file is the sum of the costs of all its simple files. If we limit the size of each complex file, then read efficiency is increased for the system. To increase write efficiency, we set a smaller size limit on each complex file. To increase read efficiency, we set a larger size limit on each complex file. If the size of a complex file reaches the limit, the system will not conduct hole-filling or merging. Instead, it just writes records in the input buffer to a new generic file on disk.

Modifications, additions, or omissions may be made to the systems, apparatuses, and/or methods described herein without departing from the scope of the disclosure. For example, various components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. A computer-implemented method, comprising:
receiving, from a client device, a plurality of data records into an input buffer, wherein the input buffer comprises a block of main memory, and wherein the input buffer acts as a queue to temporarily hold the plurality of data records;
providing a complex file comprising a plurality of simple files, wherein data records can be inserted anywhere in the complex file, and wherein each simple file contains independently sorted data records, and wherein the plurality of simple files are sorted in total order in the complex file;
merging the input buffer with the complex file, where in the merging further comprises sequentially reading a temporary block of data records into main memory from the plurality of simple files, and are compared to the records in the input buffer, and if a simple file within the plurality of simple files has a remaining size that is less than the size of the temporary block of data records then records in a subsequent simple file are read and fill the temporary block of data records.

2. The computer-implemented method of claim 1, wherein the input buffer further comprises a hard disk.

3. The computer-implemented method of claim 1, where at least one simple file in the plurality of simple files contains a plurality of holes, which are able to absorb more data records without requiring a merge.

4. The computer-implemented method of claim 3, wherein the number of holes in the plurality of holes is obtained from a predefined percentage relative to the total number of actual data records.

5. The computer-implemented method of claim 4, wherein the plurality of holes are distributed in a uniform pattern.

6. The computer-implemented method of claim 1, wherein the input buffer is a binary search tree.

7. The computer-implemented method of claim 6, wherein an offset of a simple file within the complex file is the starting position of the internal file measured by a global scope of the complex file.

8. The computer-implemented method of claim 7, wherein the offset of an internal file is the total data size of all the internal files preceding the internal file.

9. The computer-implemented method of claim 8, wherein the data size is measured by the total number of records.

10. The computer-implemented method of claim 8, wherein the data size is measured by the total number of bytes.
